(19) United States
(12) Patent Application Publication
(10) Pub. No.: US 2010/0089149 A1
(43) Pub. Date: Apr. 15, 2010

(54) SYSTEM AND PROCESS FOR NON-DESTRUCTIVE DENSITY AND MOISTURE INSPECTION

(75) Inventor: John Wendt, Columbus, OH (US)

Correspondence Address: STANDLEY LAW GROUP LLP, 6300 Riverside Drive, Dublin, OH, 43017, US

(73) Assignee: AUTOMATION AND CONTROL TECHNOLOGY, INC, Dublin, OH (US)

(21) Appl. No.: 12/406,947

(22) Filed: Mar. 18, 2009

Related U.S. Application Data
(60) Provisional application No. 61/104,635, filed on Oct. 10, 2008.

(51) Int. Cl. G01N 9/00; G01N 5/02

(52) U.S. Cl. 73/32 R; 73/73

(57) ABSTRACT

A non-destructive inspection system having a density and moisture detection system for use with the automated production of liquid filled pellets, including products having liquid filled pellets embedded in other materials. The inspection system may also have a micro controller for product detection, inspection, and rejection. The inspection system is able to be incorporated within the production line so as not to affect productivity.

### CROSS-REFERENCE TO RELATED APPLICATIONS

This application is a non-provisional patent application and claims priority to Co-pending U.S. Application No. 61/104,635 filed Oct. 10, 2008, which is hereby incorporated by reference in their entirety.

### TECHNICAL FIELD

The present invention relates generally to non-destructive density and moisture inspection. More particularly, the present invention relates to non-destructive density and moisture inspection to maintain manufacturing standards as applied to liquid filled pellets.

### BACKGROUND AND SUMMARY OF THE INVENTION

Liquid filled pellets are becoming more common in consumer products ranging from recreational activities such as paintball, breath mints, skin care products, and cigarette filters. Liquid filled pellets may comprise an outer coating containing a liquid therein. Liquid filled pellets allow for delivery of the contained liquid at a prescribed time by rupturing the outer coating allowing the liquid contained therein to escape. The outer coating may be ruptured in a number of ways including crushing or dissolving. Liquid filled pellets may be produced alone or embedded in another material. A concern of manufacturers of liquid filled pellets is the ability to ensure that the liquid filled pellets remain intact through the manufacturing process. As manufacturing techniques become more automated quality control issues become an ever increasing concern.

In industries utilizing embedded liquid filled pellet, these concerns are amplified as the liquid filled pellets cannot be visually inspected. Manufacturers are in need of a system that detects whether the liquid filled pellets are present, positioned correctly, and intact. Systems utilizing X-ray technology have been developed in an attempt to maintain the quality of products manufactured with liquid filled pellets. Although x-ray systems have the capability to determine if the liquid filled pellets are present, positioned correctly and intact, this system's accuracy begins to fail as the production speeds increase. In addition, x-ray systems may not accurately determine if a leak is present in the liquid filled pellet. Infrared sensors have also been used in the manufacturing process, but fail to provide the accuracy required.

As demand for products utilizing liquid filled products increase, the speed with which they are manufactured is increased to keep up with demand. As a result, manufacturing techniques are becoming automated. As such there is a need for a system that not only is capable of detecting if the liquid filled pellets are present, positioned correctly, and intact, but be able to maintain a high level of accuracy at these increased production speeds. In addition, an inspection system must be able to be integrated into an automated manufacturing process.

The inspection system described herein, meets these needs by providing an automated system and allowing liquid filled pellet manufactures to produce at least a 99.7% defect free product. The inspection system provided herein may also accommodate production speeds of 1000 products per minute. Some exemplary embodiments, may be able to handle even greater speeds. Exemplary embodiments of the present invention comprise a density sensor. The density sensor may be used to ensure the presence of a liquid filled pellet and that the pellet is placed at the correct location. The density sensor may be in electrical communication with a micro controller. The micro control may be programmed to analyze the data from the density sensor to ensure product quality.

The micro controller may compare the location of the pellets in the product with the desired predetermined locations saved to its memory. If the pellet placement is correct the product continues through the manufacturing process. If the pellet placement is incorrect the product is discarded as defective.

In other exemplary embodiments, the inspection system may have a moisture sensor. As the products containing liquid filled pellets pass through the moisture sensor this information is transmitted to a micro controller. The micro controller then compares the measured moisture values to saved predetermined moisture values. If the measured moisture content deviates from the predetermined moisture content, the product is rejected.

In other exemplary embodiments, the inspection system may have both a density sensor and a moisture sensor. The sensors may be in communication with a micro controller. The micro controller then uses the sensor data to determine if the pellet is properly located and if the pellet is intact. If the pellet is placed incorrectly or if the pellet is defective and moisture has escaped, the rod containing the pellet may be ejected from the system. If the pellets contained within the rod are manufactured correctly, the rod may continue through the manufacturing process.

In other exemplary embodiments, the inspection system may be able to detect when a product to be analyzed has entered an inspection zone. This may allow the inspection system to provide consistent and accurate measurements of density and moisture.

In other exemplary embodiments, the inspection system may be located in the production line so as not to interrupt manufacturing of the product. In other exemplary embodiments, the inspection system may be separate from the production line.

In addition to the novel features and advantages mentioned above, other objects and advantages of the present invention will be readily apparent from the following descriptions of the drawings and exemplary embodiments.

### BRIEF DESCRIPTION OF THE DRAWINGS

A better understanding of the disclosed embodiments will be obtained from a reading of the following detailed description and the accompanying drawings wherein identical reference characters refer to identical parts in which:

FIG. 1 is a side view of an exemplary embodiment of a product having embedded liquid filled pellets.

FIG. 2 is a cross-sectional view at line II of an exemplary embodiment of a product having embedded liquid filled pellets as seen in FIG. 1.

FIG. 3 is an exemplary embodiment of an on-line inspection system having a density sensor.

FIG. 4 is an exemplary embodiment of an inspection systems user display showing correct placement of the liquid filled pellets.

FIG. 5 is an exemplary embodiment of an inspection system user display showing incorrect placement of the liquid filled pellets.

FIG. 6 is an exemplary embodiment of an on-line inspection system having a moisture sensor.

FIG. 7 is an exemplary embodiment of an inspection system user display illustrating measured moisture content within an allowable range.

FIG. 8 is an exemplary embodiment of an inspection system user display illustrating measured moisture content outside of an allowable range.

FIG. 9 is an exemplary embodiment of an inspection system user display illustrating a display and data parameters setup screen.

FIG. 10 is an exemplary embodiment of an inspection system user display illustrating a rod parameter setup screen.

FIG. 11 is an exemplary embodiment of an inspection system user display illustrating a reject parameter setup screen.

FIG. 12 is an exemplary embodiment of an inspection system user display illustrating a shift setup screen.

### DETAILED DESCRIPTION OF EXEMPLARY EMBODIMENT(S)

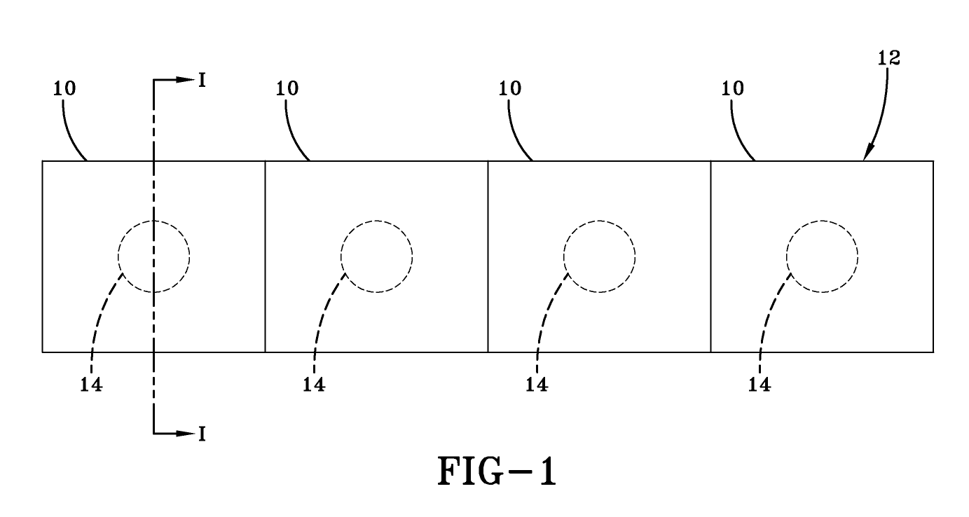

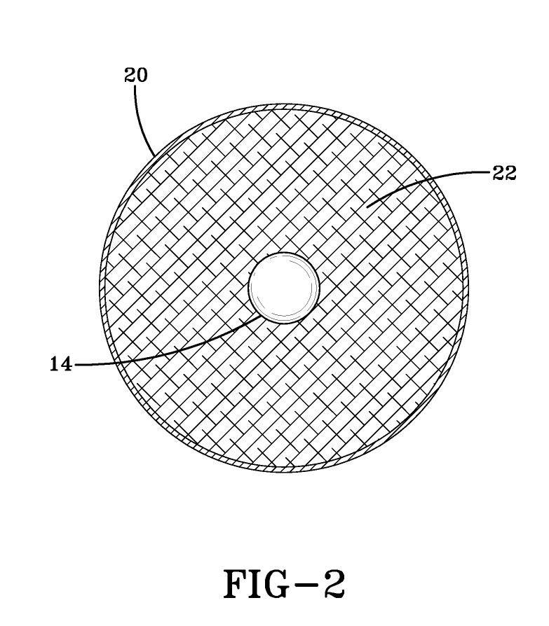

Although applicable to a variety of products utilizing liquid filled pellet technology, the claimed invention may be described in an exemplary embodiment used in the manufacturing of cigarette filters having liquid filled pellets embedded therein. As shown in FIG. 1, a typical filter 10 may be manufactured as a rod 12. The rod 12 may be comprised of a number of individual filters 10. As shown in FIG. 1, the rod 12 comprises four lengths, each of which may be used as a filter 10. A liquid filled pellet 14 may be positioned at a specific location inside each filter 10. As seen in the cross-sectional view found in FIG. 2, the filter 10 may be comprised of a plurality of layers. An outer layer 20 may be comprised of paper or other suitable casing material. An inner layer 22 may include fibrous or absorbent materials. The pellet 14 may be located within the inner layer 22.

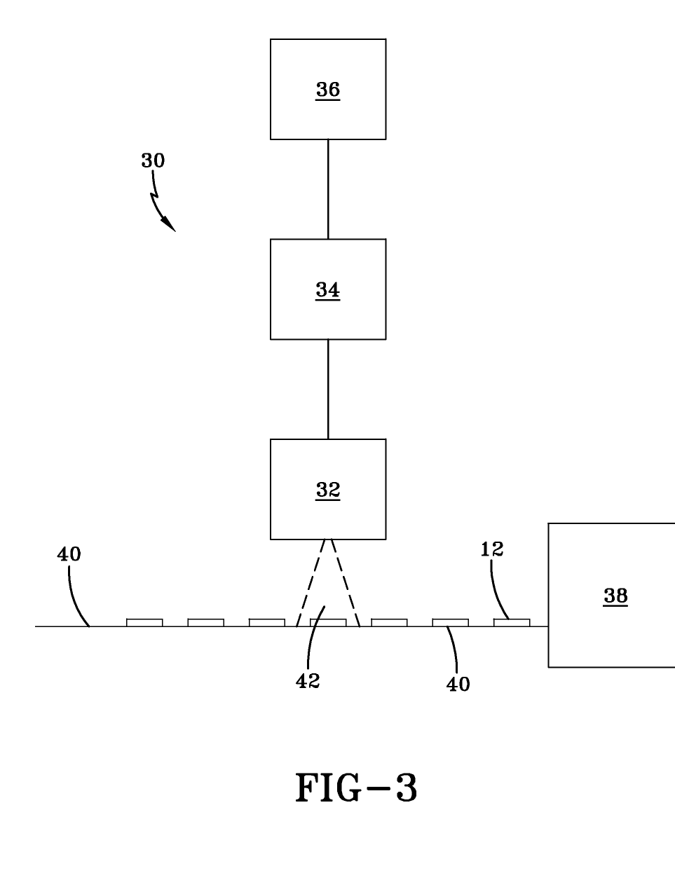

FIG. 3 illustrates an exemplary embodiment of the inspection system 30, the inspection system 30 may provide a density sensor 32 to determine if a pellet 14 is present and positioned correctly within the rod 12. In this embodiment, the inspection system 30 may be controlled by a micro controller 34. The micro controller 34 may be in electrical communication with the density sensor 32. The micro controller 34 may also be in electrical communication with a computer 36. The computer 36 may be used to input information to the micro controller 34 and provide a means of monitoring the inspection system 30. In one embodiment, the inspection system 30 may be installed on-line. In this embodiment, the density sensor 32 may be arranged so that the track array 40 carrying the rods 12, passes directly through the sensing area of the density sensor 32 creating a density inspection zone 42 on the track array 40. In this configuration the micro controller 34 may also be in communication with the rod manufacturing unit 38 and the track array 40. This on-line arrangement provides little to no interruption to the manufacturing process and allows for communication between the manufacturing process and the inspection system 30.

To start the sensing process a series of setup parameters are input into the inspection system 30. The setup parameters may include the type of rod 12 being produced and the correct locations of the pellets 14 therein. The setup parameters may also include the speed at which the manufacturing will take place. After the parameters have been input the inspection system 30 determines whether the inspection system 30 is in an on-line configuration. To determine if the pellet 14 is present and properly positioned in the rod 12, the inspection system 30 detects the presence of the rod 12 in the density inspection zone 42.

In one embodiment, the inspection system 30 may use an encoder to sense the start of a rod 12 for on-line applications. When the encoder provides the position presence of a rod 12 in the inspection zone 42, the inspection system 30 takes density readings of the rod 12. In another exemplary embodiment, the presence of a rod 12 is established by a voltage reading for in-line and off-line applications. In this embodiment, the inspection system 30 continually takes voltage readings of the density inspection zone 42. As a rod 12 enters the density inspection zone 42 the voltage readings will change in response to the presence of the rod 12. The inspection system 30 uses this voltage change to trigger the collection of readings of the rod 12 from the density sensor 32 while in the inspection zone 42. This collection of readings from the density sensor 32 ensures uniformity in measurements of each rod 12. In other exemplary embodiments of the on-line inspection system 30, the inspection system 30 may be in communication with the rod manufacturing unit 38 and the track array 40 and receive synchronization pulses (hereinafter “sync pulses”) to determine the beginning and end of a rod 12. These sync pulses are used to determine the positioning of a rod 12 in the density inspection zone 42.

After the rod 12 enters the density inspection zone 42, the micro controller 34 instructs the density sensor 32 to take a density reading of the rod 12. The data collected by the density sensor 32 is transmitted to the micro controller 34. The micro controller 34 translates the data to determine if the pellets 14 are present and correctly located. If the pellets 14 are found to be present and correctly located, then the rod 12 continues on the manufacturing process. If the pellets 14 are not present or not correctly located, the micro controller 34 may direct the manufacturing track array 40 to discard the defective rod 12.

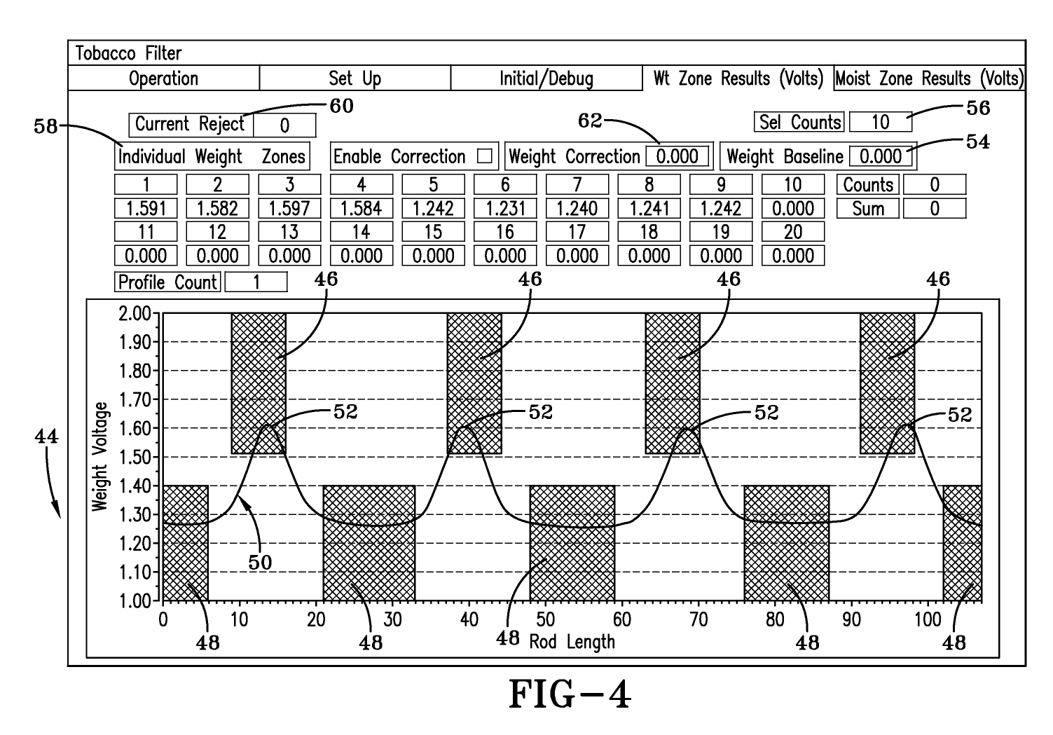

To determine if the pellets 14 are present and positioned correctly the micro controller 34 analyzes the data from the density sensor 32. To accomplish this, the micro controller 34 may produce a weight baseline 54 (as seen in FIG. 4) for the rod 12. As the rod 12 passes through the density inspection zone 42, the density sensor 32 may detect the deviation from the weight baseline 54 at pellet 14 position, if positioned correctly. The density reading may then return to the weight baseline 54 after the rod 12 position containing the pellet 14 has been inspected. The micro controller 34 uses the setup parameters to determine if the correct number of pellets 14 are present and located correctly by determining the location of the deviation points in relation to the predetermined deviation points in the setup parameters. This concept is illustrated in FIG. 4.

FIG. 4 is a graphical display of the calculations performed by the inspection system 30. The graphical representation may be displayed on attached computer 36 or other suitable device. This allows for manual adjustments and monitoring of the inspection system 30. As seen in FIG. 4, a graph 44 is displayed plotting the density of the rod 12 in the inspection zone, in weight voltage, versus the length of the rod 12. The top hatched portions 46 of the graph 44 may be areas predetermined to be pellet 14 locations within the rod 12. As such these top hatched portions 46 may be areas of expected higher weight. The bottom hatched portions 48 of the graph 44 may be areas predetermined to be locations absent pellets 14 in which a weight baseline 54 reading may be taken. As the pellets 14 are predetermine to be absent, the bottom hatched areas 48 may be areas of expected lower weight. In some exemplary embodiments, the inspection system 30 may only inspect either the top or bottom hatched portions 46 and 48. By limiting the inspection to either the high weight areas 46 or low weight areas 48, the inspection system 30 may accommodate faster production speeds. In still other exemplary embodiments, the inspection system 30 may take a density reading for both the top and bottom hatched portions 46 and 48.

As seen in FIG. 4, the line 50 is a representation of the density data as collected by the density sensor 32. The peaks 52 in the line 50 represent the increased density of the rod 12 at the pellet 14 locations as recorded by the density sensor 32. To determine if the pellets 14 are present and located correctly, the micro controller 34 compares the peaks 52 representing the collected pellet 14 data, against the top hatched portions 46, representing the areas predetermined to be pellet 14 locations. If the peak 52 is present in each top hatched portion 46, then the pellets 14 are present and correctly located. After this verification that the pellets 14 are present and correctly located, the inspection system 30 may send a signal to the track array 40 instructing the track array 40 to allow rod 12 to continue in the manufacturing process. In other exemplary embodiments, the inspection system 30 may send a signal to the track array only if the rod 12 is defective. The threshold for determining whether a rod 12 is defective may be found in the setup parameters and changes during manufacturing.

In other exemplary embodiments, the inspection system 30 may measure the bottom hatched portions 48. In this embodiment, if a peak 52 is found in the bottom hatched portion 48, the inspection system 30 determines that a pellet 14 has been misplaced. If no peak 52 is present in the bottom hatched portion 48, the inspection system 30 recognizes that the pellet 14 is correctly placed.

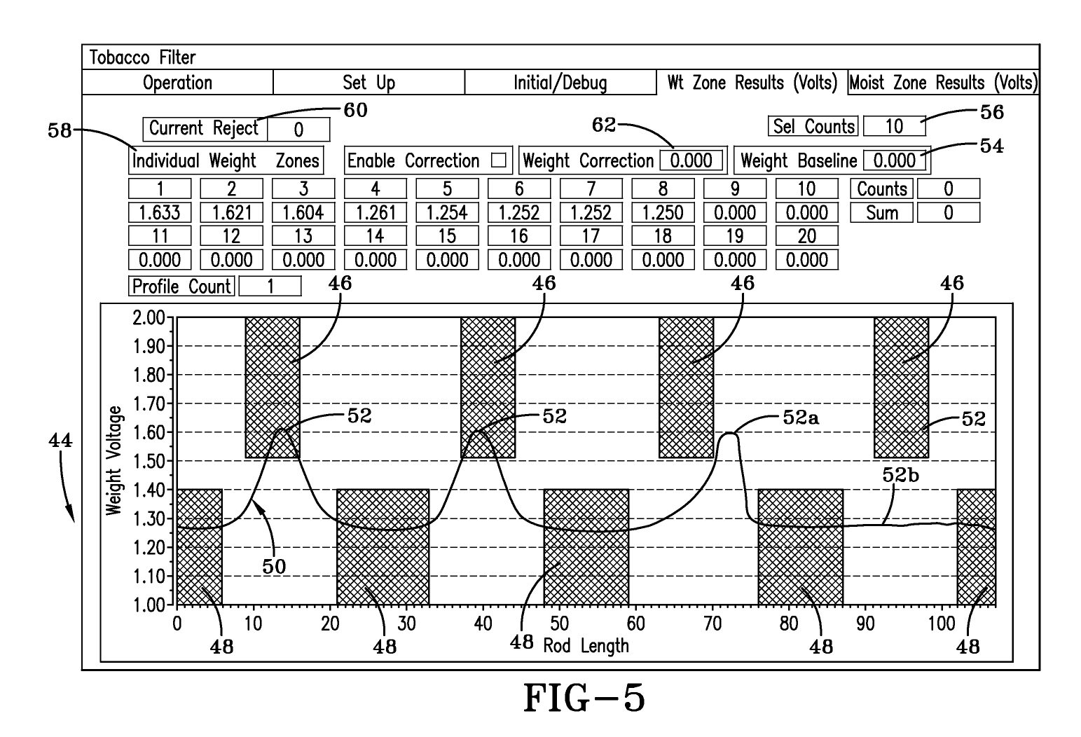

If a peak 52 is not present in each top hatch portions 46, then the pellets 14 are not present or not correctly located as shown in FIG. 5. As illustrated in FIG. 5, a peak 52 is not present on one or more of the top hatch portions 46. This is illustrated in area 52b. If a pellet 14 was present, then a peak 52 would be located in a top hatch portion 46. However, as 52b indicates a pellet 14 is absent. Another defect that may occur is illustrated by the misaligned peak 52a. Misaligned peak 52a is not located within the top hatch portion 46. The inspection system 30 may recognize this misalignment as a defect in the rod 12 and instruct the track array 40 to reject said the defective rod 12.

To improve the accuracy of the inspection system 30, the weight baseline 54 may be adjusted automatically. The automatic adjustment of the weight baseline 54 allows the inspection system 30 to compensate for density changes as a result of atmospheric conditions and changes in the materials used. To make these adjustments the inspection system 30 compares the density readings at locations predetermined to be absent pellets 14; such areas are indicated by the bottom hatched portions 48. By taking readings at these locations, the inspection system 30 may adjust the weight baseline 54. In other embodiments of the inspection system 30, the weight baseline 54 corrections may be made manually. The manual changes may be input through a computer 36, touch screen, or other suitable input device in electronic communication with the micro controller 34. The inspection system 30 may be programmed to work with any computer operating system.

As illustrated in FIGS. 4 and 5, the graphical display may provide a user with a plethora of information. The graphical display may provide the sel counts 56, individual weight zone results 58, current reject 60, weight baseline 54, and weight correction 62.

Another advantage an on-line inspection system 30 may provide is the ability to communicate with the rod manufacturing unit 38. This communication may allow for the correction of alignment issues automatically without the need to stop production and without the need for user input. One scenario where this may be beneficial may be when the rod manufacturing unit 38 may be placing the pellets 14 incorrectly such as seen in the misaligned peak 52a in FIG. 5. The inspection system 30 may notice an increase in the number of defective rods 12 and notify the rod manufacturing unit 38. The inspection system 30 may send the needed adjustments to correct any errors in the pellet 14 insertion points. To send correct adjustments, the inspection system 30 may divide the rod 12 into 1/180 portions, or subpulses. It should be understood by one skilled in the art that the number of portions may be changed depending on the application. By dividing the rod 12 into portions, the inspection system 30 may be able to provide exact corrections for pellet 14 insertions to the rod manufacturing unit 38.

In other exemplary embodiments of the inspection system 30, the sync pulses may be used to track defective rods 12 as they move through the track array 40. The setup parameters loaded into the inspection system 30 may provide the number of sync pulses between the density inspection zone 42 and a reject valve on the track array 40. The inspection system 30 may then direct the track array 40 to eject the defective rod 12 once the defective rod 12 reaches the reject valve. In still other exemplary embodiments the track array 40 may have multiple reject valves.

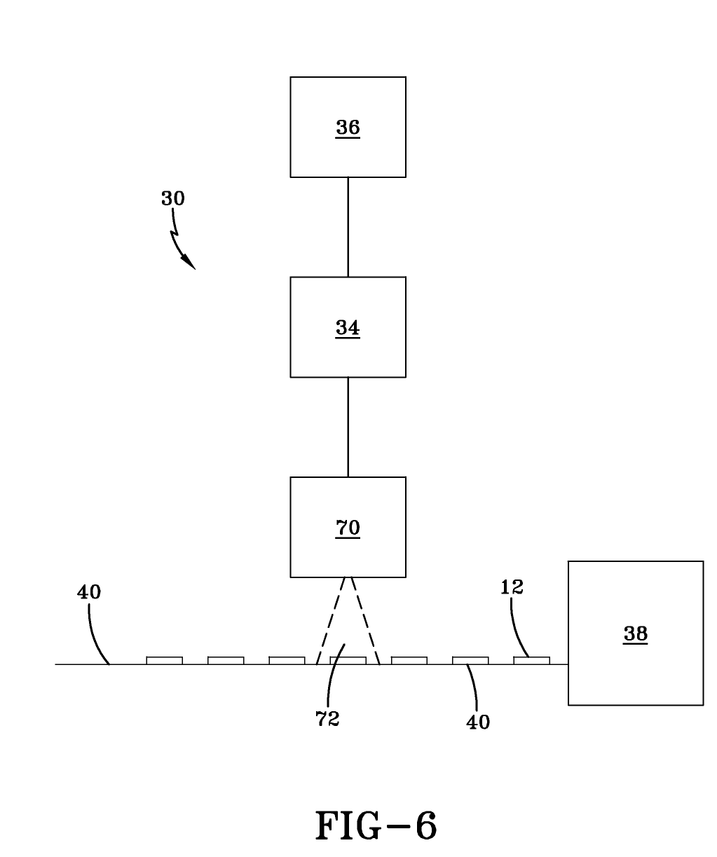

In other exemplary embodiments, the inspection system 30 may also have a moisture senor 70 as provided in FIG. 6. An example of a moisture sensor 70 that may be used would be a microwave sensor model number 3011 manufactured by TEWS Technologies, although it should be understood that any suitable moisture sensor 70 may be used. The inclusion of a moisture sensor 70 may allow the inspection system 30 to detect leaking or broken pellets 14. In the embodiment depicted in FIG. 6, the inspection system 30 may be installed on-line with a rod manufacturing unit 38. This on-line configuration may decrease the evaporation time of the any escaped liquid. By decreasing the evaporation time of the escaped liquid, the inspection system 30 may provide more accurate moisture detection.

With regard to FIG. 6, the track array 40 may be arranged to run adjacent to the moisture sensor 70. The area of the track array 40 where the moisture readings are taken is referenced to as the moisture inspection zone 72. As with the inspection system 30 having a density sensor 32, the moisture in the rod 12 is inspected when a rod 12 is present in the moisture inspection zone 72. To determine when a rod 12 enters the moisture inspection zone 72, the inspection system 30 may employ an encoder, monitor for voltage changes, or pulse readings.

Once the rod 12 enters the moisture inspection zone 72, the inspection system 30 orders the moisture sensor 70 to begin taking readings. The data collected by the moisture sensor 70 is transmitted to the micro controller 34. The micro controller 34 analyzes the data to determine of the pellet 14 is intact. If the pellets 14 within rod 12 are found to be intact, the rod 12 continues through the manufacturing process. If the pellets 14 are found to be broken or leaking, the inspection system 30 may direct the track array 40 to discard the defective rod 12.

To determine if the pellets 14 are intact, the micro controller 34 creates a moisture range for the rod 12. As the rod 12 passes through the moisture inspection zone 72, any deviations in moisture are noted. The inspection system 30 compares the Δ moisture limit to the measured moisture Δ. The comparison of the change in moisture allows the inspection system 30 to account for the migratory nature of the liquid after it has escaped the pellet 14. A deviation in the moisture content of the rod 12 may indicate a break or leaking in the pellet 14 allowing the premature escape of the liquid contained therein.

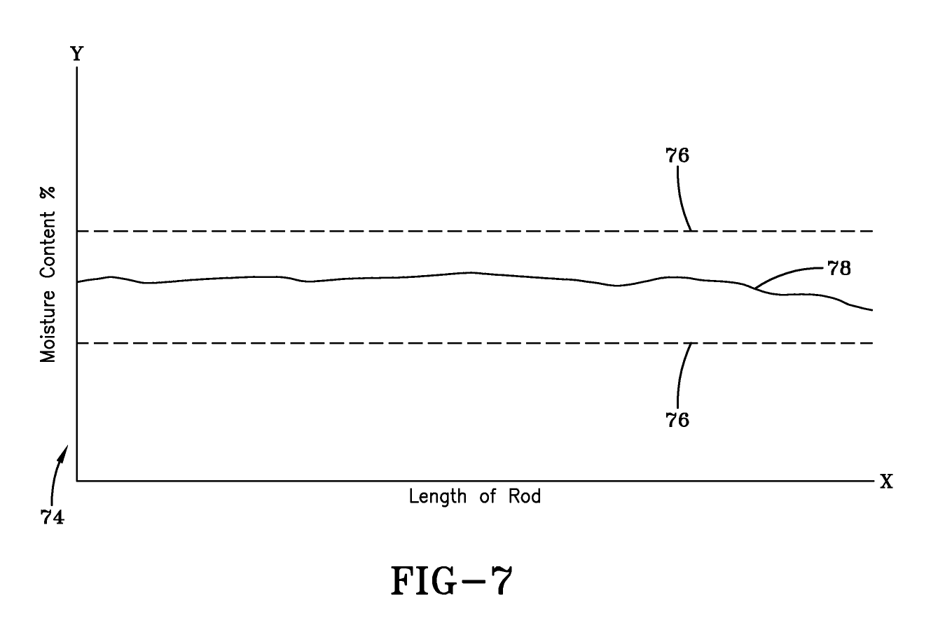

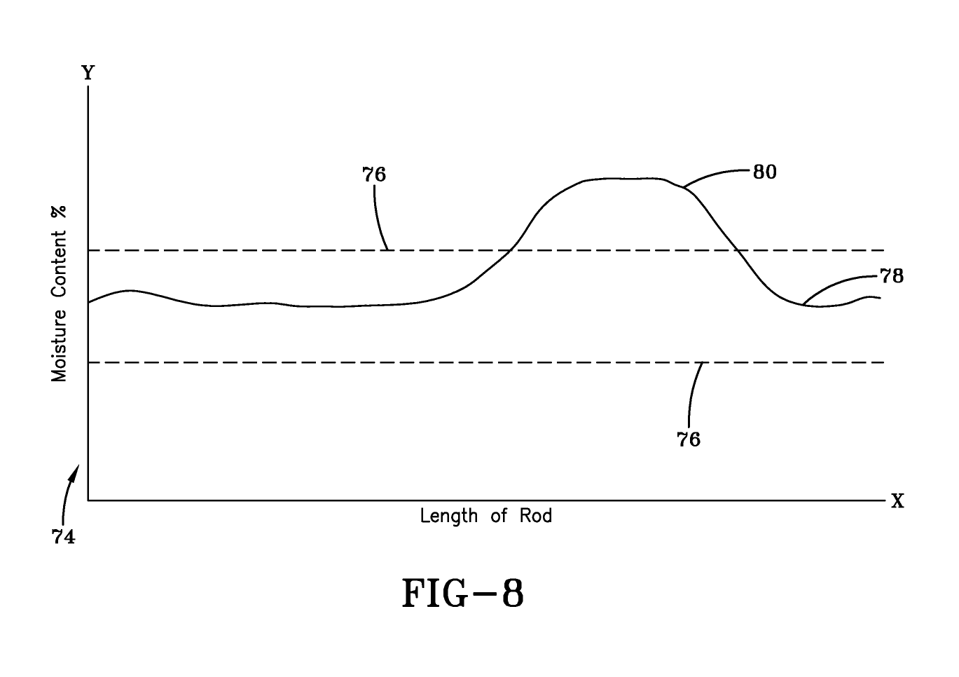

The moisture calculations may be graphically displayed, such as those found in FIG. 7. The inspection system 30 creates a moisture range, indicated by dashed lines 76, for the rod 12. The moisture range for the product being manufactured may be included in the setup parameters. The graphical representation displayed on the computer 36, touch screen, or other suitable device may allow a user to manually adjust and monitor the inspection system 30. The graph 74 may plot the moisture content of the rod 12 in the moisture inspection zone 72, versus the length of the rod 12. The moisture data is transmitted to the micro controller 34. The line 78 represents the moisture content data collected by the moisture sensor 70. If the moisture content of the rod 12, represented by line 78, falls within the predetermined moisture range the rod 12 is allowed to proceed through the manufacturing process. If, as seen in FIG. 8, the moisture content of the rod 12 falls outside the predetermined moisture range, indicated at area 80, this is an indication that the liquid contained within the pellet 14 has escaped. The inspection system 30 would then direct the track array 40 to discard the defective rod 12.

As with the density sensor 32, the moisture sensor 70 may be controlled by a micro controller 34. The micro controller 34 may be a programmable micro controller 34 such as those supplied by Tern Incorporated, located in St. Davis, Calif. The micro controller 34 may be in electronic communication with the moisture sensor 70 and detection devices of the inspection system 30, track arrays 40, manufacturing machinery, and display and input units in association with the inspection system 30.

To improve the accuracy of the inspection system 30, the moisture content range may be adjusted automatically. The automatic adjustment of the moisture range may allow the inspection system 30 to compensate for moisture changes as a result of atmospheric conditions and changes in materials used.

In some exemplary embodiments, the inspection system 30 may include both a moisture sensor 70 and a density sensor 32. The inclusion of both a moisture and density sensor 70 and 32, allows the inspection system 30 to determine if the pellet 14 is present, correctly located, and intact without the need for other inspection devices or methods. The sensors 70 and 32 may be in communication with the same micro controller 34 or may be in communication with individual micro controllers 34.

In exemplary embodiments of the inspection system 30 having both a density sensor and moisture sensor 32 and 70, the density inspection zone 42 and the moisture inspection zone 72 may be located at different areas on the track array 40. In still other exemplary embodiments, the density inspection zone 42 and the moisture inspection zone 72 may be located in substantially the same area of the track array 40.

In some exemplary embodiments, the inspection system 30, may be located between manufacturing devices. In still other embodiments, with the density or moisture inspection zones 42 and 72, may be located between manufacturing devices. Although located between manufacturing devices, the inspection system 30 may still remain in an in-line configuration so as not to interrupt the manufacturing process. With respect to cigarette filter manufacturing the inspection system 30 may be located between a plug shooter and tipping unit receiver.

In still other exemplary embodiments, the inspection system 30 may be located separately from a rod manufacturing unit 38 and track array 40, in an off-line configuration. In this exemplary embodiment, trays of products utilizing liquid filed pellets 14 may be transported to the inspection system 30 located separate from the production line. The pellets 14 may be scanned in a similar fashion to the in-line configuration, and the defective products are discarded and the compliant products may be reinserted into the production line.

The off-line embodiment of the inspection system 30 will utilize a voltage change to determine if a rod 12 is in the density or moisture inspection zone 42 and 72. As the off-line inspection system 30 is not in communication with a rod manufacturing unit 38, the inspection system 30 may have a clock. The clock allows the inspection system 30 to monitor the location and progress of the rod 12 through the inspection process and allows the defective rods 12 to be discarded. To achieve greater accuracy both an on-line and in-line inspection system 30 may be used and in some case an off-line inspection system 30 is used as well.

It should be understood by those of ordinary skill in the art that the inspection system 30 described herein may be used with any liquid filled pellet production system, including but not limited to medicinal liquid filled pellet inserted into absorbent applicators.

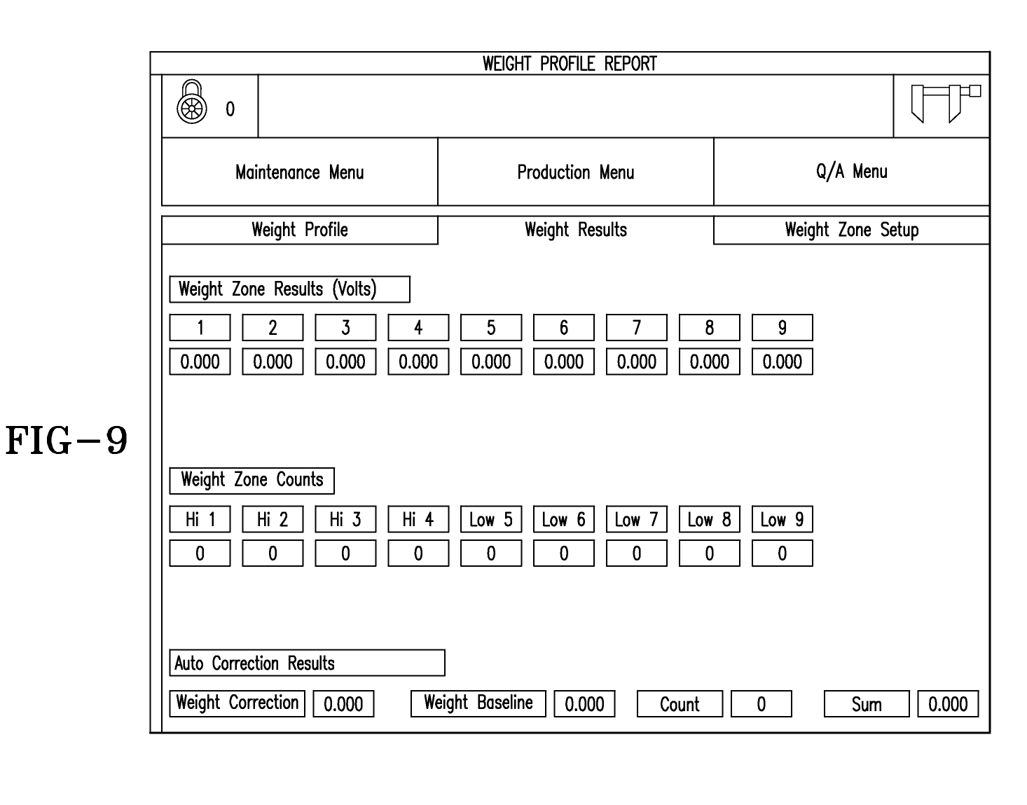

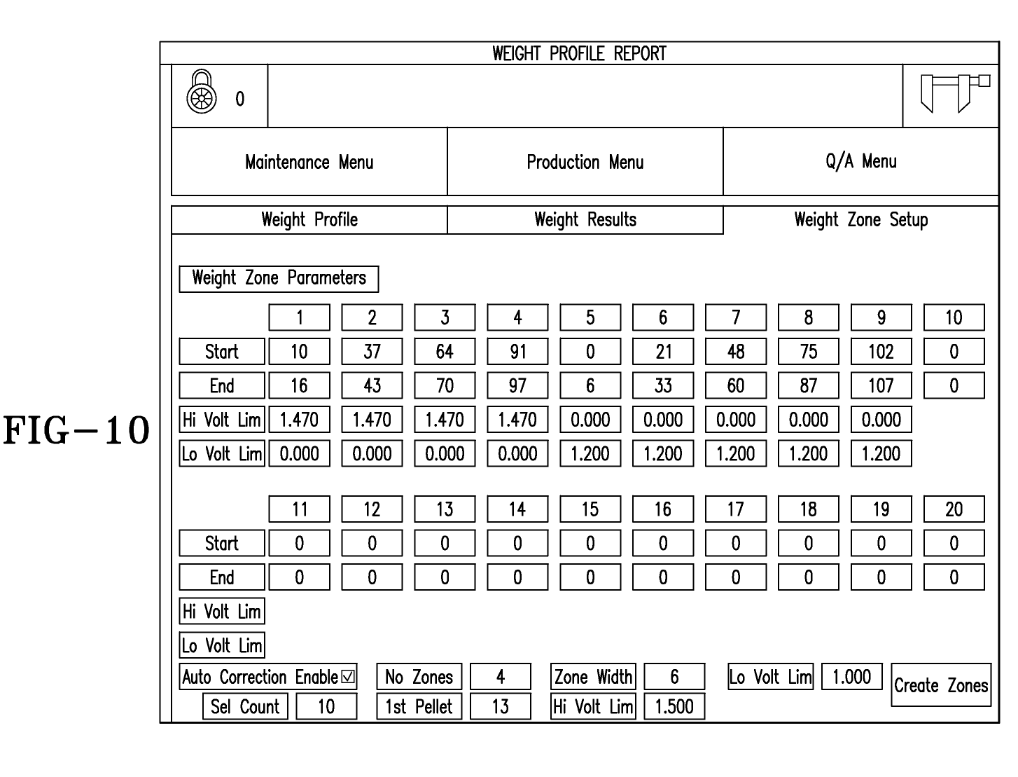

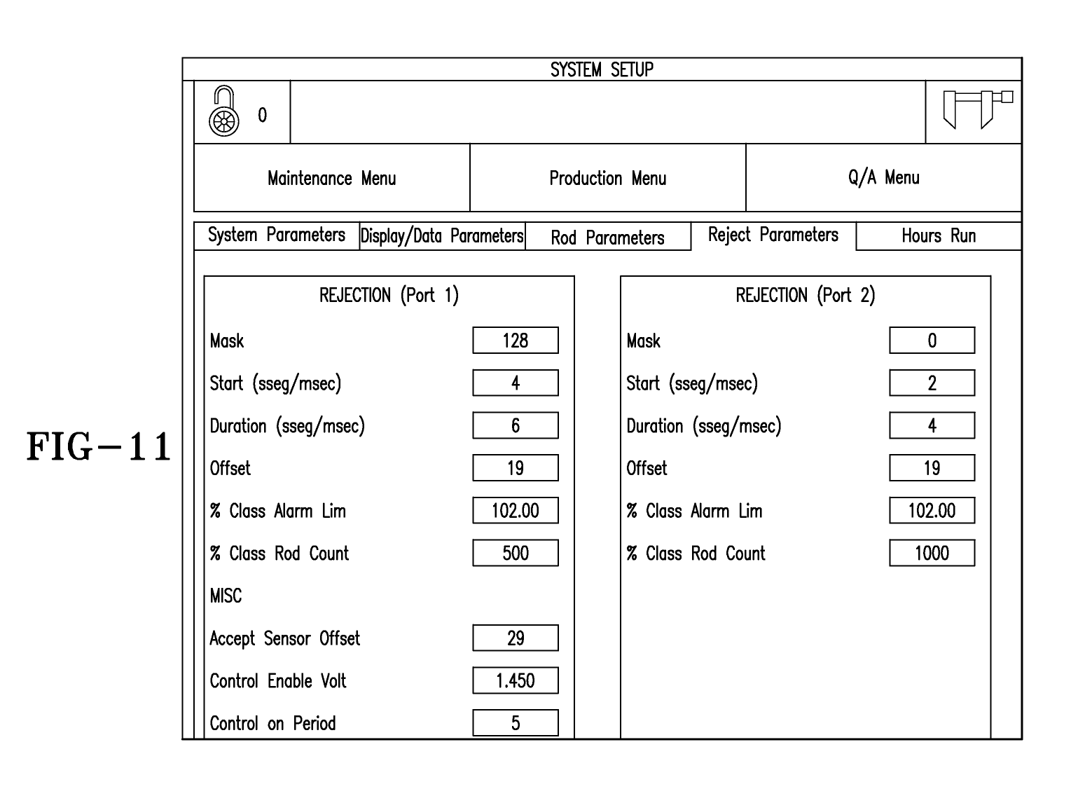

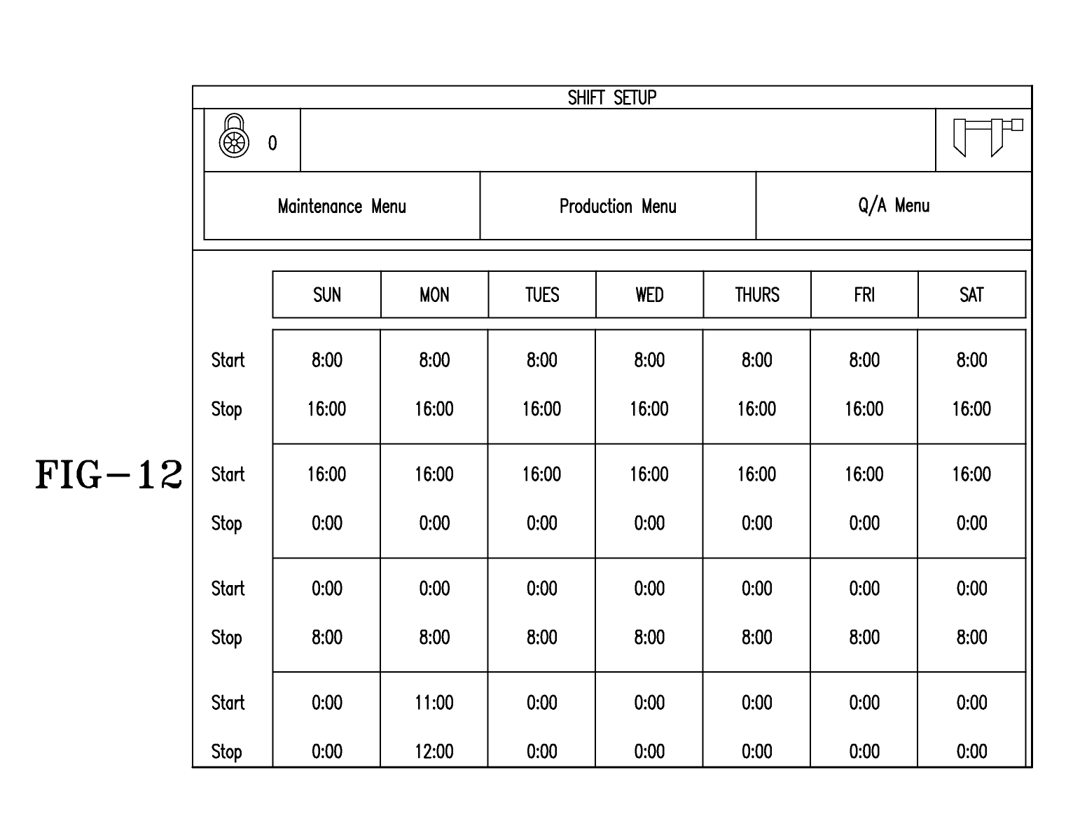

Exemplary embodiments of the inspection system 30 provide a variety of tools to increase productivity and provide feedback to a user. The use of a computer 36 or other similar device for monitoring and the input of setup parameters may also increase the efficiency of the inspection system 30. The setup parameters may include the data to be displayed to a user such as those in FIG. 9. The rod parameters may also be input into the inspection system 30 through the computer 36 or other similar device as seen in FIG. 10. The computer 36 may also provide a means of inputting the rod rejection parameters as seen in FIG. 11. The inspection system 30 may also allow monitoring and adjustments to production as seen in FIG. 12. Many other features may be incorporated into the inspection system 30 depending on the product being manufactured. Such features may include current product production information, product recipe menus, product recipe editors, history screens (gauge checks, log files, etc.), system diagnostic routines and features, remote diagnostics and troubleshooting capabilities, software backup and restore routines. In some embodiments, the number of production shift information recorded may be expandable. In other exemplary embodiments, OPC servers may be included. In other exemplary embodiments, the micro controller 34 may provide automatic sampling control. In still other embodiments, the inspection system 30 may have data management capabilities. The inspection system 30 may be able to interface with Microsoft SQL, Oracle, or other suitable database application.

Any exemplary embodiment may include any of the optional or preferred features of the other embodiments. The exemplary embodiments herein disclosed are not intended to be exhaustive or to unnecessarily limit the scope of the invention. The exemplary embodiments were chosen and described in order to explain the principles of the claimed invention so that others skilled in the art will realize that many variations and modifications may be made to affect the described invention. Many of those variations and modifications will provide the same result and fall within the spirit of the claimed invention. It is the intention, therefore, to limit the invention only as indicated by the scope of the claims.

What is claimed is:

1. A non-destructive inspection system for a liquid filled pellet product, comprising:
a density sensor;
a moisture sensor;
an inspection zone; and
a controller in communication with said density sensor and said moisture sensor; said controller adapted to receive data collected by said density and moisture sensors.

2. The non-destructive inspection system for a liquid filled pellet product of claim 1 further comprising a liquid filled pellet product detector, said detector in communication with said controller and senses when a liquid filled pellet product enters said inspection zone.

3. The non-destructive inspection system for a liquid filled pellet product of claim 1 wherein said data is a density and moisture reading of said liquid filled pellet product.

4. The non-destructive inspection system for a liquid filled pellet product of claim 1 wherein said non-destructive inspection system is used on an on-line continuous manufacturing process.

5. The non-destructive inspection system for a liquid filled pellet product of claim 1 wherein said non-destructive inspection system is used on an off-line manufacturing process.

6. The non-destructive inspection system for a liquid filled pellet product of claim 4 wherein said controller is in communication with a liquid filled pellet product manufacturing unit.

7. The non-destructive inspection system for a liquid filled pellet product of claim 1 wherein said controller is in communication with a computer, said computer allowing user input and monitoring of said non-destructive inspection system.

8. A non-destructive inspection system for a liquid filled pellet product, comprising:
a density sensor;
a moisture sensor;
an inspection zone;
a product detector, said product detector senses when a liquid filled pellet product enters said inspection zone; and
a controller in communication with said density and moisture sensors and said product detector.

9. The non-destructive inspection system for a liquid filled pellet product of claim 8 wherein said density and moisture sensors collect data from said liquid filled pellet product while in said inspection zone.

10. The non-destructive inspection system for a liquid filled pellet product of claim 8 wherein the data collected is the density and moisture of said liquid filled pellet product.

11. The non-destructive inspection system for a liquid filled pellet product of claim 8 wherein said non-destructive inspection system is used on an on-line continuous manufacturing process.

12. The non-destructive inspection system for a liquid filled pellet product of claim 8 wherein said non-destructive inspection system is used on an off-line manufacturing process.

13. The non-destructive inspection system for a liquid filled pellet product of claim 11 wherein said controller is in communication with a liquid filled pellet product manufacturing unit.

14. The non-destructive inspection system for a liquid filled pellet product of claim 8 wherein said controller is in communication with a computer, said computer allowing user input and monitoring of said non-destructive inspection system.

15. A method of non-destructive inspection of a liquid filled pellet product using a non-destructive inspection system, comprising:
providing a liquid filled pellet product;
passing said liquid filled pellet product through an inspection zone;
detecting when said liquid filled pellet product enters said inspection zone;
collecting density and moisture data from said liquid filled pellet product in said inspection zone through the use of a density sensor and a moisture sensor; and
communicating said density and moisture data to a controller in communication with said density and moisture sensors.

16. The method of claim 15 wherein said non-destructive inspection system is synchronized with a liquid filled pellet product manufacturing unit in an on-line configuration.

17. The method of claim 15 further comprising displaying said collected density and moisture data to a user through a computer in communication with said controller.

18. The method of claim 15 wherein said non-destructive inspection system is in an off-line configuration.

19. The method of claim 15 wherein said non-destructive inspection system may store production output of a manufacturing process.

20. The method of claim 15 wherein said computer allows user input to said non-destructive inspection system.
